(19) United States
(12) Patent Application Publication
(10) Pub. No.: US 2016/0313923 A1
(43) Pub. Date: Oct. 27, 2016

(54) METHOD FOR ACCESSING MULTI-PORT MEMORY MODULE AND ASSOCIATED MEMORY CONTROLLER

(71) Applicants: MEDIATEK INC., Hsin-Chu (TW); National Chiao Tung University, Hsinchu (TW)

(72) Inventors: Bo-Cheng Lai, Hualien County (TW); Jiun-Liang Lin, Taipei City (TW); Kuo-Cheng Lu, Hsinchu City (TW)

(21) Appl. No.: 15/098,336

(22) Filed: Apr. 14, 2016

Related U.S. Application Data
(60) Provisional application No. 62/150,862, filed on Apr. 22, 2015.

(51) Int. Cl. G06F 3/06

(52) U.S. Cl. CPC G06F 3/065; G06F 3/0619; G06F 3/0673

(57) ABSTRACT

A method for accessing a multi-port memory module comprising a plurality of banks is provided. In one embodiment, the method comprises: generating a plurality of parities, wherein each parity is generated according to bits of a portion of the banks; and writing the parities into the banks, respectively. In another embodiment, the method comprises: when two bits corresponding to two different addresses within a specific bank are requested to be read in response to two read commands, directly reading the bit corresponding to one of the two different address of the specific bank; and generating the bit corresponding to the other address of the specific bank by reading the bits of the other banks without the specific bank.

### CROSS REFERENCE TO RELATED APPLICATIONS

This application claims the priority of U.S. Provisional Application No. 62/150,862, filed on Apr. 22, 2015, which is included herein by reference in its entirety.

### BACKGROUND

A multi-port memory module generally comprises a plurality of banks for storing data, and each bank is allowed to be accessed independently. However, when the memory receives two or more read commands to access the addresses within a single bank, a bank conflict occurs and the read commands are required to be sequentially executed, causing memory access latency and worse memory access efficiency. To solve this problem, the conventional multi-port memory module uses a customized circuit to enable multiple access ports, or assigns more memory cells to support more concurrent accesses. These methods, however, may increase the design and manufacture cost and/or increase the chip area and power consumption. Therefore, how to provide to a memory control method to support the multiple accesses efficiently is an important topic.

### SUMMARY

It is therefore an objective of the present invention to provide a method for accessing a multi-port memory module, which can lower the probability of the bank conflict and increase the access efficiency, to solve the above-mentioned problems.

According to one embodiment of the present invention, a method for accessing a multi-port memory module comprising a plurality of banks is provided, and the method comprises: generating a plurality of parities, wherein each parity is generated according to bits of a portion of the banks; and writing the parities into the banks, respectively.

According to another embodiment of the present invention, a memory controller coupled to a multi-port memory module comprising a plurality of banks is provided. The memory controller is arranged for generating a plurality of parities, and writing the parities into the different banks, respectively, wherein each parity is generated according to bits of a portion of the banks.

According to another embodiment of the present invention, a method for accessing a multi-port memory module comprising a plurality of banks is provided, and the method comprises: when two bits corresponding to two different addresses within a specific bank are requested to be read in response to two read commands, directly reading the bit corresponding to one of the two different address of the specific bank; and generating the bit corresponding to the other address of the specific bank by reading the bits of the other banks without the specific bank.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a memory controller according to one embodiment of the present invention.

FIG. 2 is a data layout of the banks according to one embodiment of the present invention.

FIG. 3 shows a case when the memory controller sends one write command W12 and two read commands R20 and R11 to access the memory module according to one embodiment of the present invention.

FIG. 4 shows a case when the memory controller further sends one write command W23 and two read commands R21 and R22 to access the memory module according to one embodiment of the present invention.

FIG. 5 shows a case when the memory controller further sends one write command W16 and two read commands R14 and R15 to access the memory module according to one embodiment of the present invention.

FIG. 6 is a flowchart of a method for accessing the multi-port memory module according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

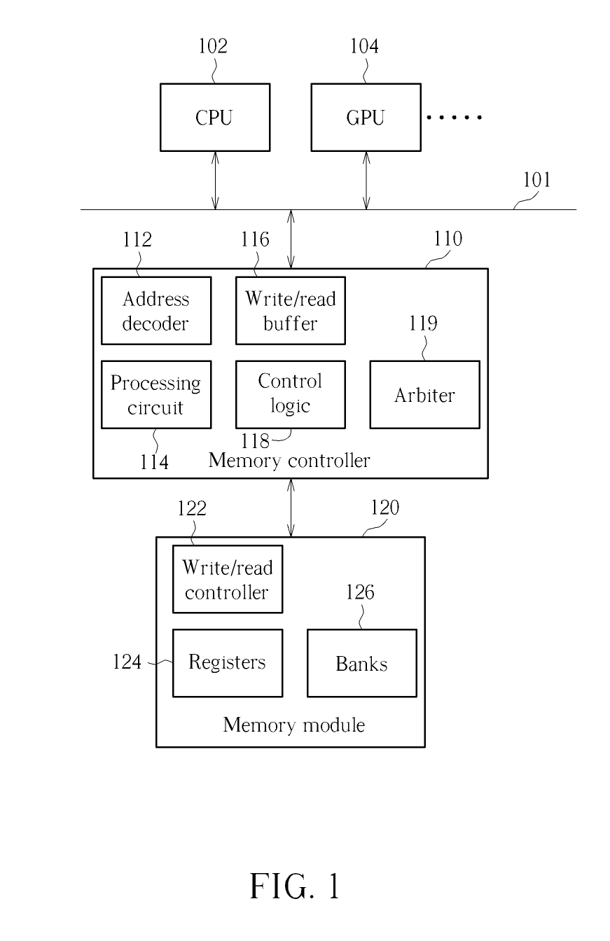

Please refer to FIG. 1, which is a diagram illustrating a memory controller 110 according to one embodiment of the present invention. As shown in FIG. 1, the memory controller 110 is coupled to a memory module 120, and is coupled to elements need to access the memory module 120 such as a central processing unit (CPU) 102 and a graphics processing unit (GPU) 104 via a bus 101. In addition, the memory controller 110 may comprises an address decoder 112, a processing circuit 114, a write/read buffer 116, a control logic 118 and an arbiter 119; and the memory module 120 comprises a write/read controller 122, a plurality of registers 124 and a plurality of banks 120. In this embodiment, the memory module 120 is a multi-port memory module supporting two or more read/write operations; and each of the banks 126 has independent read/write ports for supporting multiple accesses, and is allowed to be accessed independently. In addition, the memory module 120 may be a multi-port static random access memory (SRAM) module or a multi-port dynamic random access memory (DRAM), however, this is not a limitation of the present invention.

Regarding the operations of the elements within the memory controller 110, the address decoder 112 is arranged to decode a received signal from the CPU 102 or GPU 104 or the other elements required to access the memory module 120 to generate a plurality of read command(s) and/or write command(s); the processing circuit 114 is arranged to manage and process the read/write commands; the write/read buffer 116 is arranged to temporarily store the data to be written into the memory module 120 and/or to store the data read from the memory module 120; the control logic 118 is arranged to generate the bits and corresponding parities in response to the write command, and to generate the bits in response to the read command according to the data read from the memory module 120; and the arbiter 119 is arranged to schedule the write commands and the read commands.

Regarding the elements within the memory module 120, the write/read controller 122 may comprises a row decoder and a column decoder, and is arranged to decode the write/read command(s) from the memory controller 110 to access the bit(s) corresponding to the address within the banks 120 specified by the write/read command(s); the registers 124 is arranged to temporarily stores the parities; and each of the banks 126 is implemented by one or more memory chips for storing data.

In the embodiment of the present invention, the parities are generated according to the data stored in the banks 126 or the data to be stored in the banks 126, and the parities are evenly written into the banks 126. By using this method, the memory controller 110 can simultaneously obtain two bits corresponding to the addresses within a single bank, to reduce the probability of bank conflict. Detailed descriptions of the embodiment are as follows.

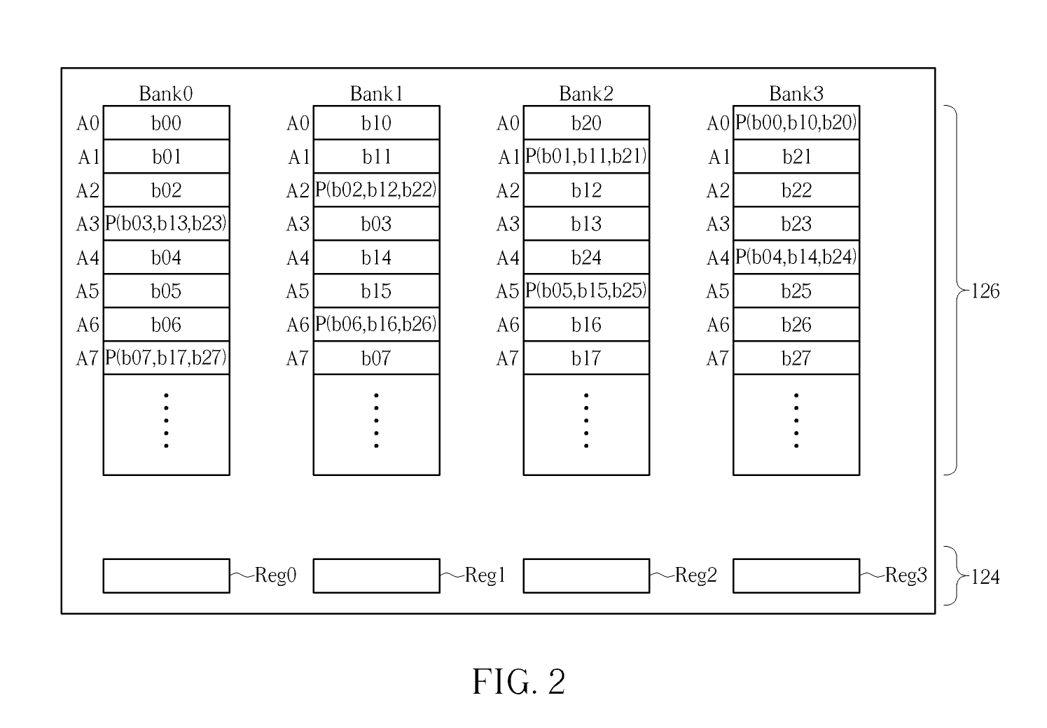

Please refer to FIG. 2, which is a data layout of the banks according to one embodiment of the present invention, wherein FIG. 2 shows that the banks 126 comprises four banks Bank0-Bank3, and the registers 124 comprises four registers Reg0-Reg3 corresponding the banks Bank0-Bank3, and each bank has two read ports and one write port (2R1W), but it's not a limitation of the present invention. As shown in FIG. 2, data of three banks are distributed into four banks Bank0-Bank3, and the parities are evenly distributed into the banks Bank0-Bank3. In detail, the parity P(b00, b10, b20) is generated by performing exclusive-or (XOR) operations upon the bits b00, b10 and b20 corresponding the addresses A0 of the banks Bank0-Bank2, that is P(b00, b10, b20)=b00⊕b10⊕b20, wherein the symbol “⊕” is an XOR operator. Then, the parity P(b00, b10, b20) is stored into the cell having the address A0 of the bank Bank3.

Similarly, the parity P(b01, b11, b21) is generated by performing XOR operations upon the bits b01, b11 and b21 corresponding the addresses A1 of the banks Bank0, Bank1 and Bank3, and the parity P(b01, b11, b21) is stored into the cell having the address A1 of the bank Bank2. The parity P (b02, b12, b22) is generated by performing XOR operations upon the bits b02, b12 and b22 corresponding the addresses A2 of the banks Bank0, Bank2 and Bank3, and the parity P(b02, b12, b22) is stored into the cell having the address A2 of the bank Bank1. The parity P(b03, b13, b23) is generated by performing XOR operations upon the bits b03, b13 and b23 corresponding the addresses A3 of the banks Bank1-Bank3, and the parity P (b03, b13, b23) is stored into the cell having the address A3 of the bank Bank0. Similarly, the parities P(b04, b14, b24), P(b05, b15, b25), P(b06, b16, b26) and P(b07, b17, b27), are written into the banks Bank3, Bank2, Bank1 and Bank0, respectively.

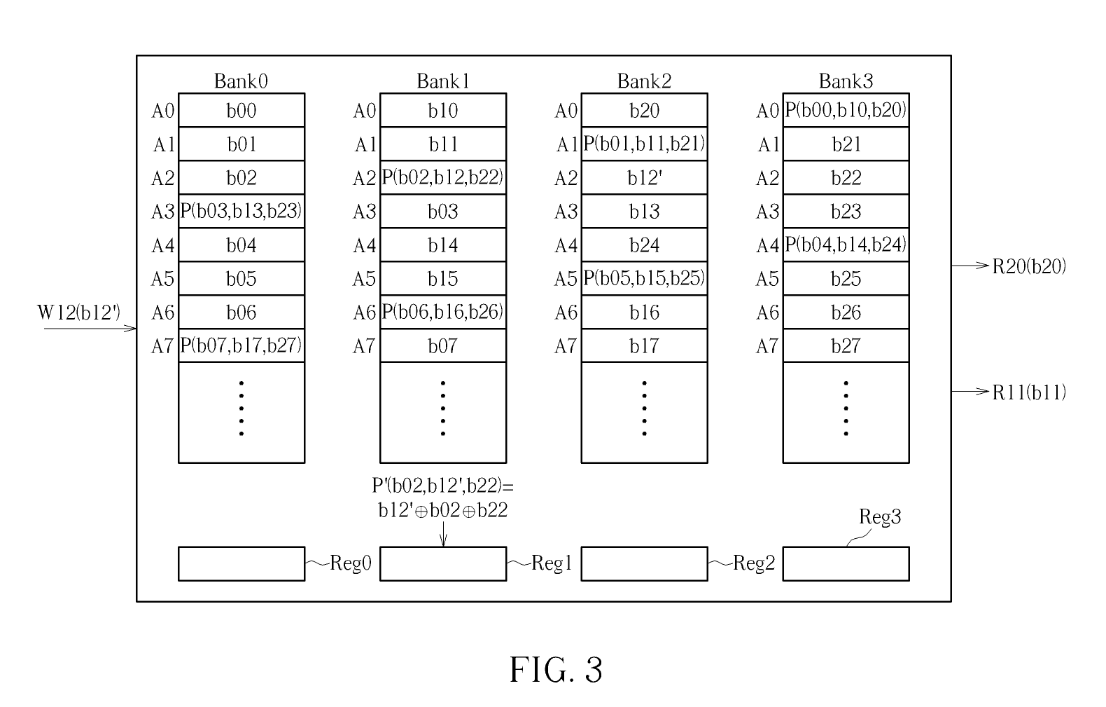

FIG. 3 shows a case when the memory controller 110 sends one write command W12 and two read commands R20 and R11 to access the memory module 120 according to one embodiment of the present invention, wherein the write command W12 controls the memory module 120 to write a bit b12′ into the cell having the address A2 of the bank Bank2 (i.e. using the bit b12′ to update the bit b12), and the read commands R20 and R11 control the memory module 120 to read data b20 and b11 from the banks Bank2 and Bank1, respectively. In FIG. 3, because the read commands R20 and R11 do not introduce the bank conflict, so the memory controller 110 can directly read the bits b20 and b11 from the banks Bank2 and Bank1, respectively. In addition, when the data bit b12′ is written into the cell having the address A2 of the bank Bank2, the memory controller 110 further reads the bits b02 and b22 from the banks Bank0 and Bank3, respectively, and performs the XOR operations upon the bits b12′, b02 and b22 to generate an updated parity P′(b02, b12′, b22), and stores the updated parity P′(b02, b12′, b22) into the register Reg1.

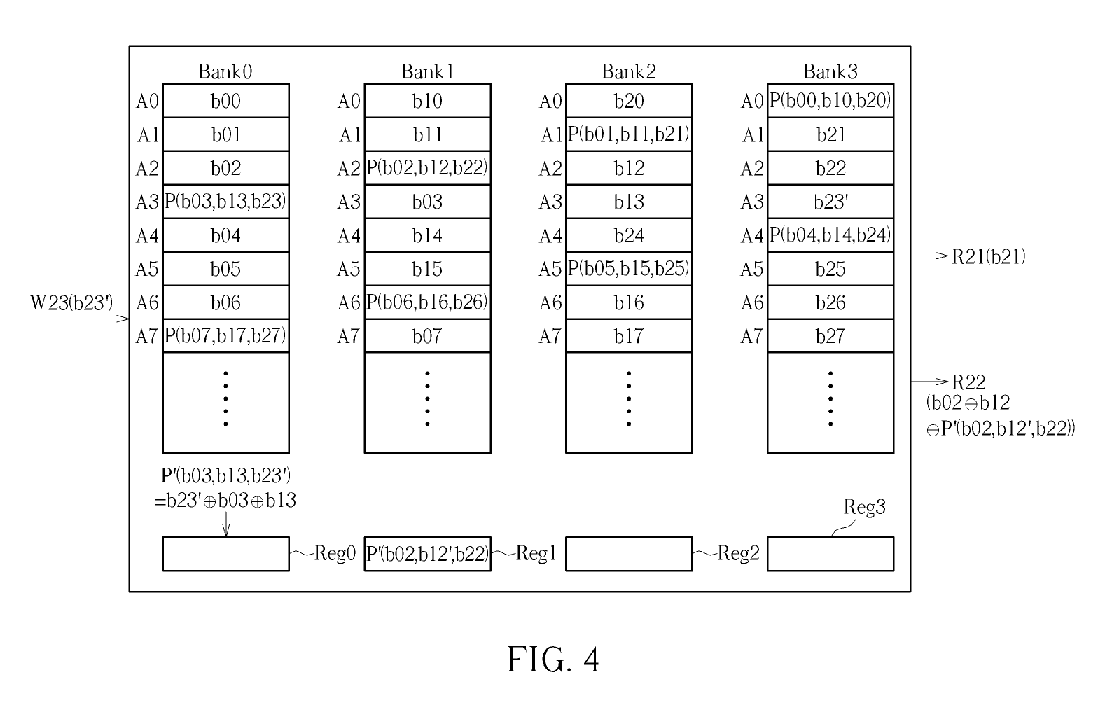

FIG. 4 shows a case when the memory controller 110 further sends one write command W23 and two read commands R21 and R22 to access the memory module 120 according to one embodiment of the present invention, wherein the embodiment shown in FIG. 4 follows the embodiment shown in FIG. 3. In FIG. 4, the write command W23 controls the memory module 120 to write a bit b23′ into the cell having the address A3 of the bank Bank3 (i.e. using the bit b23′ to update the bit b23), and the read commands R21 and R22 control the memory module 120 to read data b21 and b22 from the banks. In this embodiment, because the bits b21 and b22 belong to the same bank Bank3, a bank conflict occurs and the memory controller 110 is not allowed to directly read the bits b21 and b22 from the bank Bank3 simultaneously. Therefore, the memory controller 110 only directly reads one of the bits b21 and b22 from the bank Bank3 (in this embodiment, the memory controller 110 directly reads the bit b21), and the other bit (i.e. the bit b22) is generated by performing XOR operations upon the bits b02, b12 and the updated parity P′(b02, b12′, b22) without reading the bit b22, wherein the bits b02, b12 are read from the banks Bank0 and Bank2, respectively, and the updated parity P′(b02, b12′, b22) is read from the register Reg1. By using the access method mentioned above, two read commands for accessing the same bank can be simultaneously executed to obtain the two bits (e.g. b21 and b22), and the bank conflict issue can be avoided.

In addition, regarding the write command W23, the data b23′ is written into the cell having the address A3 of the bank Bank3, the memory controller 110 further reads the bits b03 and b13 from the banks Bank1 and Bank2, respectively, and performs the XOR operations upon the bits b23′, b03 and b13 to generate an updated parity P′(b03, b13, b23′), and stores the updated parity P′(b03, b13, b23′) into the register Reg0.

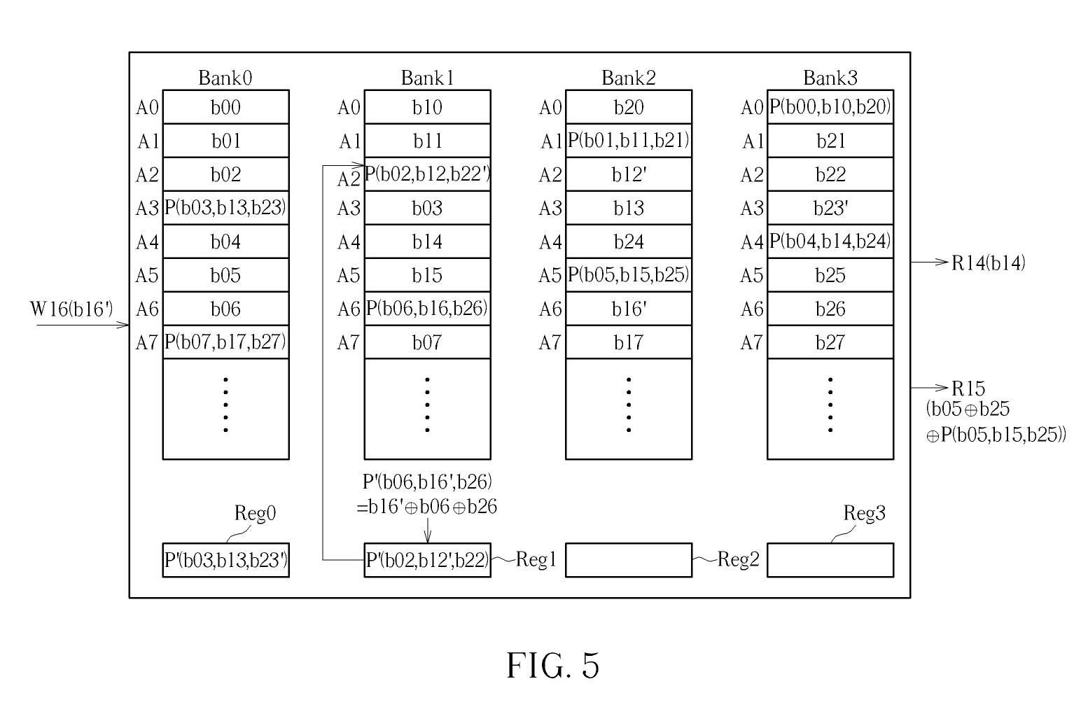

FIG. 5 shows a case when the memory controller 110 further sends one write command W16 and two read commands R14 and R15 to access the memory module 120 according to one embodiment of the present invention, wherein the embodiment shown in FIG. 5 follows the embodiment shown in FIG. 4. In FIG. 5, the write command W16 controls the memory module 120 to write a bit b16′ into the cell having the address A6 of the bank Bank2 (i.e. using the bit b16′ to update the bit b16), and the read commands R14 and R15 control the memory module 120 to read data b14 and b15 from the banks. In this embodiment, because the bits b14 and b15 belong to the same bank Bank1, a bank conflict occurs and the memory controller 110 is not allowed to directly read the bits b14 and b15 from the bank Bank1 simultaneously. Therefore, the memory controller 110 only directly reads one of the bits b14 and b15 from the bank Bank1 (in this embodiment, the memory controller 110 directly reads the bit b14), and the other bit (i.e. the bit b15) is generated by performing XOR operations upon the bits b05, b25 and the parity P(b05, b15, b25) without reading the bit b15, wherein the bits b05, b25 are read from the banks Bank0 and Bank3, respectively, and the parity P(b05, b15, b25) is read from the bank Bank2. By using the access method mentioned above, two read commands for accessing the same bank can be simultaneously executed to obtain the two bits (e.g. b14 and b15), and the bank conflict issue can be avoided.

In addition, regarding the write command W16, the data b16′ is written into the cell having the address A6 of the bank Bank2, the memory controller 110 further reads the bits b06 and b26 from the banks Bank0 and Bank3, respectively, and performs the XOR operations upon the bits b16′, b06 and b26 to generate an updated parity P′ (b06, b16′, b26). At this time, the previous updated parity P′ (b02, b12′, b22) is moved from the register Reg1 to the cell having the address A2 of the bank Bank1, and the current updated parity P′(b06, b16′, b26) is stored into the register Reg1.

It is noted that the “addresses A0-A7” shown in FIGS. 2-5 can also be regarded as the location offsets of the cells of each bank. In addition, the “address” in the embodiments is not limited to be a physical address or an address index of the bank, and a group of the bits (e.g. b00, b10 and b20) and the corresponding parity (e.g. P(b00, b10, b20)) of the banks should be considered to have the same address for the banks.

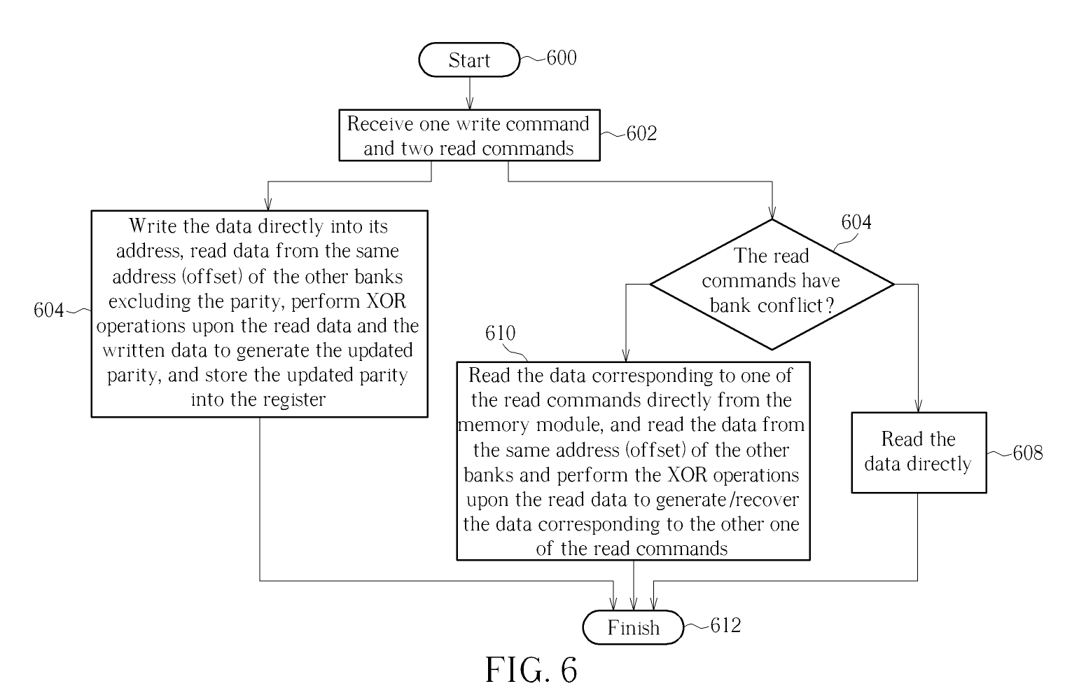

The embodiments shown in FIGS. 2-5 are summarized as a flowchart shown in FIG. 6. Referring to FIGS. 2-6, the flow is described as follows:

Step 600: The flow starts.

Step 602: Receive one write command and two read commands.

Step 604: In the write path, write the data directly into its address, read data from the same address (offset) of the other banks excluding the parity, perform XOR operations upon the read data and the written data to generate the updated parity, and store the updated parity into the register.

Step 606: In the read path, determine whether the read commands have bank conflict? If no bank conflict, the flow enters Step 608; if yes, the flow enters Step 610.

Step 608: Read the data directly.

Step 610: Read the data corresponding to one of the read commands directly from the memory module, and read the data from the same address (offset) of the other banks and perform the XOR operations upon the read data to generate/recover the data corresponding to the other one of the read commands.

Step 612: The flow finishes.

Briefly summarized, in the method for accessing a multi-port memory module of the present invention, each parity is generated by performing the XOR operations upon the data corresponding to the same address (offset) of a portion of banks, and storing the parity into the cell having the same address (offset) of the remaining bank. In addition, the parities are distributed into the banks. By using the technique of the present invention, the probability of the bank conflict can be reduced to increase the access efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for accessing a multi-port memory module comprising a plurality of banks, comprising:
generating a plurality of parities, wherein each parity is generated according to bits of a portion of the banks; and
writing the parities into the banks, respectively.

2. The method of claim 1, wherein the plurality of banks comprises M banks, each bank comprises cells corresponding to N addresses for storing N bits, respectively, and the step of generating the plurality of parities comprises:
generating a Kth parity according to each bit corresponding to a Kth address of the (M−1) banks, wherein K is any positive integer less than N, thereby generating N parities; and
the step of writing the parities into the different banks, respectively, comprises:
storing the Kth parity into the cell corresponding to the Kth address of the remaining bank.

3. The method of claim 2, wherein the step of generating the Kth parity according to each bit corresponding to the Kth address of the (M−1) banks comprises:
performing exclusive-or (XOR) operations upon the each bit corresponding to the Kth address of the (M−1) banks to generate the Kth parity.

4. The method of claim 2, wherein the N parities are evenly written into the M banks.

5. The method of claim 2, further comprising:
when the cell corresponding to the Kth address of one of the (M−1) banks is updated in response to a write command:
generating an updated Kth parity according to each bit corresponding to the Kth address of the (M−1) banks; and
storing the updated Kth parity into the Kth address of the remaining bank.

6. The method of claim 2, further comprising:
when two bits corresponding to Xth and Yth addresses within a specific bank are requested to be read in response to two read commands, directly reading the bit corresponding to the Xth address of the specific bank, wherein X and Y are any two different positive integers less than N; and
generating the bit corresponding to the Yth address of the specific bank by reading the bits corresponding to the Yth addresses of the other banks.

7. The method of claim 6, wherein the bit corresponding to the Yth address of the specific bank is generated without reading the bit of the Yth address of the specific bank.

8. The method of claim 1, wherein the multi-port memory module is a multi-port static random access memory (SRAM) module or a multi-port dynamic random access memory (DRAM), and each bank is allowed to be accessed independently.

9. A memory controller coupled to a multi-port memory module comprising a plurality of banks, arranged for generating a plurality of parities, and writing the parities into the banks, respectively, wherein each parity is generated according to bits of a portion of the banks.

10. The memory controller of claim 9, wherein the plurality of banks comprises M banks, each bank comprises cells corresponding to N addresses for storing N bits, respectively, and the memory controller generates a Kth parity according to each bit corresponding to a Kth address of the (M−1) banks, wherein K is any positive integer less than N, thereby generating N parities;
and the memory controller stores the Kth parity into the cell corresponding to the Kth address of the remaining bank.

11. The memory controller of claim 10, wherein the memory controller performs exclusive-or (XOR) operations upon each bit corresponding to the Kth address of the (M−1) banks to generate the Kth parity.

12. The memory controller of claim 10, wherein the N parities are evenly written into the M banks.

13. The memory controller of claim 10, wherein when when the memory controller sends a write command to the multi-port memory module to update the cell corresponding to the Kth address of one of the (M−1) banks, the memory controller further generates an updated Kth parity according to each bit corresponding to the Kth address of the (M−1) banks, and stores the updated Kth parity into the Kth address of the remaining bank.

14. The memory controller of claim 10, wherein when the memory controller is required to read two bits corresponding to Xth and Yth addresses within a specific bank, the memory controller directly reads the bit corresponding to the Xth address of the specific bank, wherein X and Y are any two different positive integers less than N; and the memory controller generates the bit corresponding to the Yth address of the specific bank by reading the bits corresponding to the Yth addresses of the other banks.

15. The memory controller of claim 14, wherein the bit corresponding to the Yth address of the specific bank is generated without reading the bit of the Yth address of the specific bank.

16. The memory controller of claim 9, wherein the multi-port memory module is a multi-port static random access memory (SRAM) module or a multi-port dynamic random access memory (DRAM), and each bank is allowed to be accessed independently.

17. A method for accessing a multi-port memory module comprising a plurality of banks, comprising:
when two bits corresponding to two different addresses within a specific bank are requested to be read in response to two read commands, directly reading the bit corresponding to one of the two different address of the specific bank; and
generating the bit corresponding to the other address of the specific bank by reading the bits of the other banks.

18. The method of claim 17, wherein each bank comprises N addresses for storing N of bits, respectively, and the step of generating the bit corresponding to the other address of the specific bank by reading the bits of the other banks comprises:
generating the bit corresponding to a Yth address of the specific bank by reading the bits corresponding to the Yth addresses of the other banks, wherein Y is a positive integers less than N.

19. The method of claim 18, wherein the bit corresponding to the Yth address of the specific bank is generated without reading the bit corresponding to the Yth address of the specific bank.

20. The method of claim 18, wherein the multi-port memory module is a multi-port static random access memory (SRAM) module or a multi-port dynamic random access memory (DRAM), and each bank is allowed to be accessed independently.
